(19) United States
(12) Patent Application Publication
(10) Pub. No.: US 2015/0214618 A1
(43) Pub. Date: Jul. 30, 2015

(54) COMMUNICATION DEVICE AND ANTENNA ELEMENT THEREIN

(71) Applicant: Acer Incorporated, New Taipei City (TW)

(72) Inventors: Kin-Lu Wong, New Taipei City (TW); Shan-Ni Hsu, New Taipei City (TW)

(73) Assignee: Acer Incorporated, New Taipei City (TW)

(21) Appl. No.: 14/215,479

(22) Filed: Mar. 17, 2014

(30) Foreign Application Priority Data
Jan. 28, 2014 (TW) 103103111

(51) Int. Cl. H01Q 5/50; H01Q 1/48

(52) U.S. Cl. CPC H01Q 5/50; H01Q 1/48

(57) ABSTRACT

A communication device including a ground element and an antenna element is provided. The antenna element includes a metal element, a first feeding branch, and a second feeding branch. The metal element is disposed adjacent to an edge of the ground element. The first feeding branch and the second feeding branch are respectively coupled to a first feeding point and a second feeding point on the metal element, such that the antenna element substantially has an inverted-F shape. The first feeding branch includes a first reactance circuit, and the first feeding point is coupled through the first reactance circuit to a first signal source. The second feeding branch includes a second reactance circuit, and the second feeding point is coupled through the second reactance circuit to a second signal source.

### CROSS REFERENCE TO RELATED APPLICATIONS

This Application claims priority of Taiwan Patent Application No. 103103111 filed on Jan. 28, 2014, the entirety of which is incorporated by reference herein.

### BACKGROUND OF THE INVENTION

1. Field of the Invention

The disclosure generally relates to a communication device, and more particularly, to a communication device and a small-size dual-feed inverted-F antenna element therein.

2. Description of the Related Art

In recent years, antenna elements of mobile communication devices usually use active switches to achieve their small-size and multi-band characteristics. By operating the active switches, the antenna elements can switch to different matching circuits in respective bands, or reconfigure themselves so as to obtain different resonant paths and achieve multi-band operation. However, the active switches are more complicated in the circuit design, and this leads to more complexity and higher manufacturing costs of the whole antenna system, and lower radiation efficiency of the antenna elements. Accordingly, it is a critical challenge for antenna designers to improve the design of active switches or to use passive circuits to replace the function of active switches in mobile communication devices.

### BRIEF SUMMARY OF THE INVENTION

To solve the problems of the prior art, the invention provides a novel communication device which comprises at least a small-size dual-feed inverted-F antenna element with a simple structure. The antenna element comprises two feeding branches and a metal element having a simple shape. The antenna element is excited by using the two feeding branches to generate wide high-frequency and low-frequency bands, thereby covering LTE/WWAN (Long Term Evolution/Wireless Wide Area Network) multiple frequency bands.

In a preferred embodiment, the invention provides a communication device, comprising: a ground element, having an edge; and an antenna element, comprising a metal element, a first feeding branch, and a second feeding branch, wherein the metal element is disposed adjacent to the edge of the ground element, and the first feeding branch and the second feeding branch are respectively coupled to a first feeding point and a second feeding point on the metal element, such that the antenna element substantially has an inverted F-shape; wherein the first feeding branch comprises a first reactance circuit, the first feeding point is coupled through the first reactance circuit to a first signal source, the second feeding branch comprises a second reactance circuit, and the second feeding point is coupled through the second reactance circuit to a second signal source.

The metal element of the antenna element has two feeding points (i.e., the first feeding point and the second feeding point). In some embodiments, when the antenna element is fed through the first feeding point by a first feeding signal of the first signal source, the antenna element is excited to generate a first frequency band, and when the antenna element is fed through the second feeding point by a second feeding signal of the second signal source, the antenna element is excited to generate a second frequency band. Frequencies of the first frequency band are lower than frequencies of the second frequency band. In some embodiments, the first frequency band is from about 704 MHz to about 960 MHz, and the second frequency band is from about 1710 MHz to about 2690 MHz. In some embodiments, the metal element substantially has a straight-line shape or an inverted L-shape. In some embodiments, the first feeding point and the second feeding point are both positioned at or adjacent to a side or an end of the metal element. With such a design, the first feeding point and the second feeding point can make full use of the resonant path provided by the metal element. Therefore, the size of the metal element is used optimally, and the antenna element of the invention has small-size, simple-structure, and multi-band characteristics.

In some embodiments, when the antenna element operates in the first frequency band, the first reactance circuit provides a high reactance value in the second frequency band. As a result, the first reactance circuit has approximate band-rejection characteristics in the second frequency band, and the second feeding signal of the second signal source does not affect the performance of the antenna element operating in the first frequency band. In some embodiments, the first reactance circuit is further configured to increase the bandwidth of the first frequency band.

In some embodiments, when the antenna element operates in the second frequency band, the second reactance circuit provides a high reactance value in the first frequency band. As a result, the second reactance circuit has approximate band-rejection characteristics in the first frequency band, and the first feeding signal of the first signal source does not affect the performance of the antenna element operating in the second frequency band. In some embodiments, the second reactance circuit is further configured to increase the bandwidth of the second frequency band.

In some embodiments, the metal element is disposed inside a clearance region, and does not overlap with the ground element. In some embodiments, the first reactance circuit and the second reactance circuit are both disposed on the ground element. In alternative embodiments, the first reactance circuit and the second reactance circuit are both disposed inside the clearance region, and do not overlap with the ground element. In some embodiments, the first reactance circuit, the second reactance circuit, and the metal element are all integrated on a dielectric substrate, and do not overlap with the ground element. That is, the first reactance circuit and the second reactance circuit may not occupy any design space on the ground element.

In some embodiments, the antenna element of the invention just occupies a small clearance region (e.g., the total area of the clearance region may be just 30×10 mm²), and is capable of covering the wide first and second frequency bands (e.g., LTE/WWAN frequency bands from about 704 MHz to about 960 MHz, and further from about 1710 MHz to about 2690 MHz). In comparison to conventional designs, the invention replaces active switches with passive circuits, and it effectively reduces the whole system complexity and enhances the whole antenna efficiency.

### BRIEF DESCRIPTION OF DRAWINGS

The invention can be more fully understood by reading the subsequent detailed description and examples with references made to the accompanying drawings, wherein:

FIG. 1 is a diagram of a communication device according to a first embodiment of the invention;

FIG. 2 is a diagram of S-parameters relative to an antenna element of a communication device according to a first embodiment of the invention;

FIG. 3 is a diagram of antenna efficiency relative to an antenna element of a communication device according to a first embodiment of the invention;

FIG. 4 is a diagram of a communication device according to a second embodiment of the invention; and

FIG. 5 is a diagram of a communication device according to a third embodiment of the invention.

### DETAILED DESCRIPTION OF THE INVENTION

In order to illustrate the foregoing and other purposes, features and advantages of the invention, the embodiments and figures of the invention will be described in detail as follows.

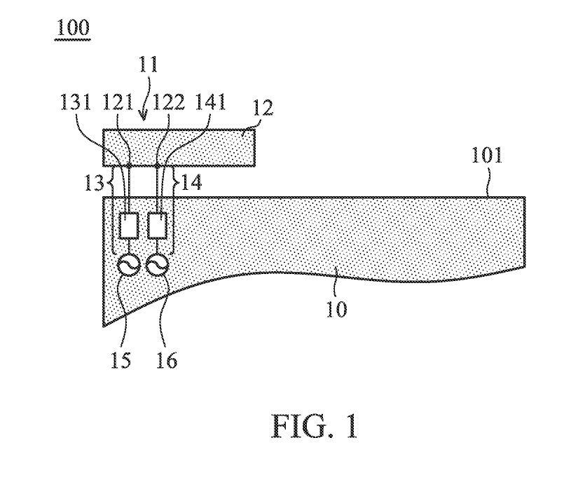

FIG. 1 is a diagram of a communication device 100 according to a first embodiment of the invention. The communication device 100 may be a smartphone, a tablet computer, or a notebook computer. As shown in FIG. 1, the communication device 100 at least comprises a ground element 10 and an antenna element 11. The antenna element 11 comprises a metal element 12, a first feeding branch 13, and a second feeding branch 14. The metal element 12 is disposed adjacent to an edge 101 of the ground element 10. The metal element 12 may substantially have a straight-line shape. The first feeding branch 13 and the second feeding branch 14 are respectively coupled to a first feeding point 121 and a second feeding point 122 on the metal element 12, such that the antenna element 11 substantially has an inverted F-shape. The first feeding branch 13 comprises a first reactance circuit 131, and the first feeding point 121 is coupled through the first reactance circuit 131 to a first signal source 15. The first reactance circuit 131 may comprise one or more capacitive elements and/or inductive elements, such as chip capacitors and/or chip inductors. The first signal source 15 may be an RF (Radio Frequency) module of the communication device 100, and it can generate a first feeding signal at a low frequency to excite the antenna element 11. The second feeding branch 14 comprises a second reactance circuit 141, and the second feeding point 122 is coupled through the second reactance circuit 141 to a second signal source 16. The second reactance circuit 141 may comprise one or more capacitive elements and/or inductive elements, such as chip capacitors and/or chip inductors. The second signal source 16 may be another RF module of the communication device 100, and it can generate a second feeding signal at a high frequency to excite the antenna element 11. In the embodiment of FIG. 1, the metal element 12 is disposed inside a clearance region which does not overlap with the ground element 10, and the first reactance circuit 131 and the second reactance circuit 141 are both disposed on the ground element 10. Note that the communication device 100 may further comprise other components, such as a touch panel, a processor, a speaker, a battery, and a housing (not shown).

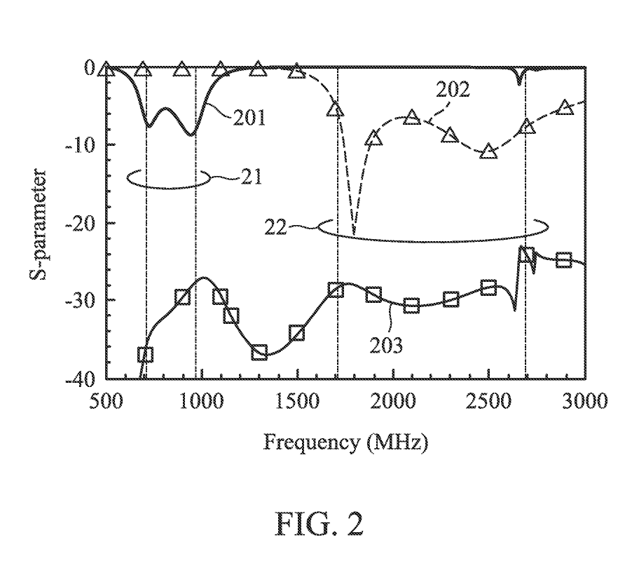

FIG. 2 is a diagram of S-parameters relative to the antenna element 11 of the communication device 100 according to the first embodiment of the invention. In some embodiments, the element sizes and element parameters of the communication device 100 are set as follows. The ground element 10 has a length of about 200 mm and a width of about 150 mm. The size of the ground element 10 is substantially equal to a typical ground plane size of a general 9.7″ tablet computer. The antenna element 11 has a length of about 30 mm and a width of about 10 mm. According to the measurement of FIG. 2, when the antenna element 11 is excited by the first signal source 15 through the first reactance circuit 131, the antenna element 11 operates in a first frequency band 21, depicted as the reflection coefficient (S₁₁) curve 201. Furthermore, when the antenna element 11 is excited by the second signal source 16 through the second reactance circuit 141, the antenna element 11 operates in a second frequency band 22, depicted as the reflection coefficient (S₂₂) curve 202. In a preferred embodiment, the first frequency band 21 covers LTE700/GSM850/900 bands from about 704 MHz to about 960 MHz, and the second frequency band 22 covers GSM1800/1900/UMTS/LTE2300/2500 bands from about 1710 MHz to about 2690 MHz. The first reactance circuit 131 has approximate band-rejection characteristics in the second frequency band 22, and therefore the second feeding signal of the second signal source 16 does not tend to affect the antenna element 11 operating in the first frequency band 21. The first reactance circuit 131 is further configured to increase the bandwidth of the first frequency band 21. The second reactance circuit 141 has approximate band-rejection characteristics in the first frequency band 21, and therefore the first feeding signal of the first signal source 15 does not tend to affect the antenna element 11 operating in the second frequency band 22. The second reactance circuit 141 is further configured to increase the bandwidth of the second frequency band 22. By using the first reactance circuit 131 and the second reactance circuit 141, the isolation (S₂₁) curve 203 of the antenna element 11 is substantially lower than −25 dB in the first frequency band 21 and the second frequency band 22, and it meets the requirements of high isolation between antennas.

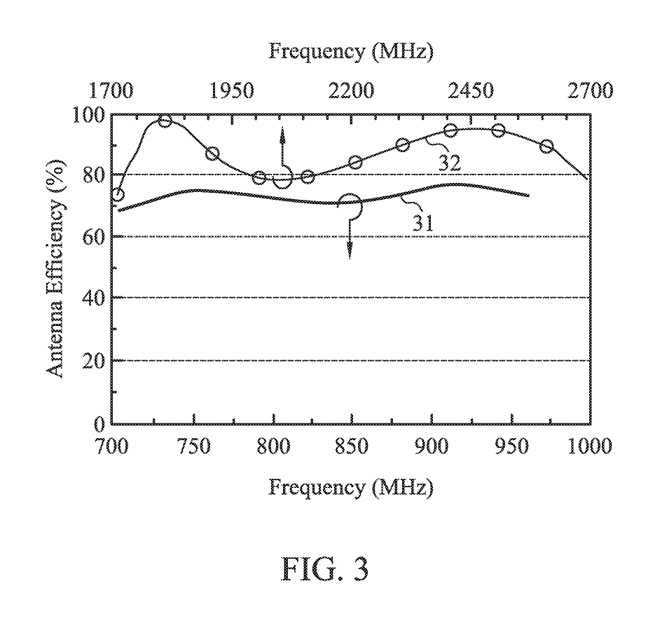

FIG. 3 is a diagram of antenna efficiency relative to the antenna element 11 of the communication device 100 according to the first embodiment of the invention. It is understood that the aforementioned antenna efficiency is radiation efficiency including return loss. According to the measurement of FIG. 3, the antenna efficiency curve 31 of the antenna element 11 operating in the first frequency band 21 (LTE700/GSM850/900 bands) is from about 67% to about 75%, and the antenna efficiency curve 32 of the antenna element 11 operating in the second frequency band 22 (GSM1800/1900/UMTS/LTE2300/2500 bands) is from about 73% to about 96%. Therefore, the antenna efficiency of the antenna element 11 meets the requirements of practical applications.

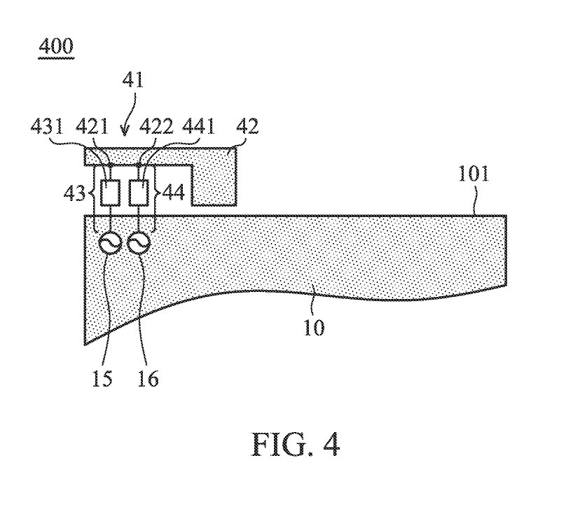

FIG. 4 is a diagram of a communication device 400 according to a second embodiment of the invention. FIG. 4 is similar to FIG. 1. In the second embodiment, a first reactance circuit 431, a second reactance circuit 441, and a metal element 42 of an antenna element 41 are all disposed inside a clearance region. In other words, none of the metal element 42, the first reactance circuit 431, or the second reactance circuit 441 overlaps with the ground element 10. In some embodiments, the metal element 42, the first reactance circuit 431, and the second reactance circuit 441 are all integrated with and formed on a dielectric substrate, such as an FR4 (Flame Retardant 4) substrate, and the dielectric substrate does not overlap with the ground element 10. Furthermore, the metal element 42 substantially has an inverted L-shape to make full use of the area of the clearance region. In other embodiments, the metal element 42 has a different shape, such as an inverted U-shape or an inverted J-shape. Other features of the second embodiment are similar to those of the first embodiment. Accordingly, the two embodiments can achieve similar levels of performance.

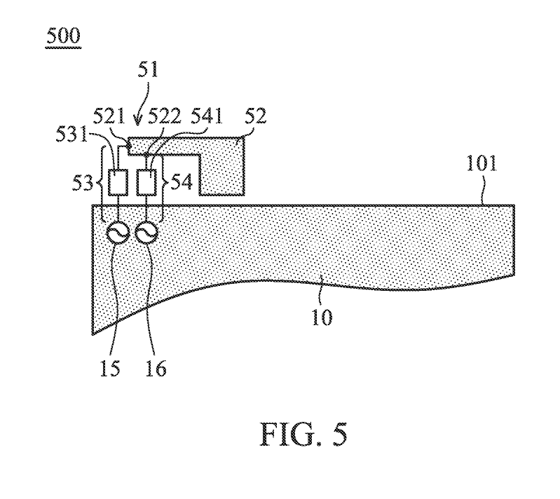

FIG. 5 is a diagram of a communication device 500 according to a third embodiment of the invention. FIG. 5 is similar to FIG. 1. In the third embodiment, a first feeding point 521 and a second feeding point 522 of an antenna element 51 are positioned at or adjacent to a side or an end of a metal element 52, such that the first feeding point 521 and the second feeding point 522 both make full use of the resonant path provided by the metal element 52. More particularly, the metal element 52 comprises a non-equal-width structure, and the non-equal-width structure comprises a narrow portion and a wide portion. The first feeding point 521 may be positioned at one end of the narrow portion, and the second feeding point 522 may be positioned at one side of the narrow portion. Other features of the third embodiment are similar to those of the first embodiment. Accordingly, the two embodiments can achieve similar levels of performance.

Note that the above element sizes, element shapes, and frequency ranges are not limitations of the invention. An antenna designer can fine tune these settings or values according to different requirements. It is understood that the communication device and the antenna element of the invention are not limited to the configurations of FIGS. 1-5. The invention may merely include any one or more features of any one or more embodiments of FIGS. 1-5. In other words, not all of the features displayed in the figures should be implemented in the communication device and the antenna element of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a ground element, having an edge; and
an antenna element, comprising a metal element, a first feeding branch, and a second feeding branch, wherein the metal element is disposed adjacent to the edge of the ground element, and the first feeding branch and the second feeding branch are respectively coupled to a first feeding point and a second feeding point on the metal element, such that the antenna element substantially has an inverted F-shape;
wherein the first feeding branch comprises a first reactance circuit, the first feeding point is coupled through the first reactance circuit to a first signal source, the second feeding branch comprises a second reactance circuit, and the second feeding point is coupled through the second reactance circuit to a second signal source.

2. The communication device as claimed in claim 1, wherein the metal element substantially has a straight-line shape or an inverted L-shape.

3. The communication device as claimed in claim 1, wherein none of the metal element, the first reactance circuit, or the second reactance circuit overlaps with the ground element.

4. The communication device as claimed in claim 1, wherein the first feeding point and the second feeding point are positioned at or adjacent to a side or an end of the metal element.

5. The communication device as claimed in claim 1, wherein the antenna element at least operates in a first frequency band and a second frequency band, and frequencies of the first frequency band are lower than frequencies of the second

6. The communication device as claimed in claim 5, wherein the first frequency band is from about 704 MHz to about 960 MHz, and the second frequency band is from about 1710 MHz to about 2690 MHz.

7. The communication device as claimed in claim 5, wherein the first reactance circuit has approximate band-rejection characteristics in the second frequency band.

8. The communication device as claimed in claim 5, wherein the second reactance circuit has approximate band-rejection characteristics in the first frequency band.

9. The communication device as claimed in claim 5, wherein the first reactance circuit is configured to increase bandwidth of the first frequency band.

10. The communication device as claimed in claim 5, wherein the second reactance circuit is configured to increase bandwidth of the second frequency band.
